(19) United States
(12) Patent Application Publication
(10) Pub. No.: US 2014/0111804 A1
(43) Pub. Date: Apr. 24, 2014

(54) Heterodyne Optical Spectrum Analyzer

(71) Applicant: Ruediger Maestle, Boeblingen (DE)

(72) Inventor: Ruediger Maestle, Boeblingen (DE)

(73) Assignee: AGILENT TECHNOLOGIES ,INC., Loveland, CO (US)

(21) Appl. No.: 14/008,495

(22) PCT Filed: Mar. 28, 2011
(86) PCT No.: PCT/EP2011/054711

§ 371 Date: Dec. 10, 2013

(51) Int. Cl. G01J 3/447

(52) U.S. Cl. CPC G01J 3/447
USPC 356/364

(57) ABSTRACT

A heterodyne optical spectrum analyzer (10) is configured for analyzing spectral information of an optical input signal (15). The analyzer (10) comprises a local oscillator source (20) configured for generating an optical local oscillator signal (38). An optical mixer (25) is configured for receiving the input signal (15) and the local oscillator signal (38), and for outputting a plurality of different combined optical signals (50), each combined optical signal (50) being derived from the input signal (15) and the local oscillator signal (38). An opto-electrical receiver (30) having a plurality of inputs (52) is configured for receiving the combined optical signals (50) and for providing an opto-electrical conversion thereof, and an output (54) for outputting electrical signals representing the received combined optical signals (50). A signal processor (35) is configured for deriving spectral information of the input signal (15) by analyzing the electrical signals. The optical mixer (25) is configured for deriving a plurality of polarization diverse signals from the input signal (15), each polarization diverse signal having a different state of polarization, and deriving a set of balanced quadrature signals for each polarization diverse signal by combining each polarization diverse signal with a signal derived from the local oscillator signal (38). The derived sets of balanced quadrature signals represent the plurality of combined optical signals (50).

### BACKGROUND ART

The present invention relates to detection oaf optical signals with a heterodyne optical spectrum analyzer.

In high-speed optical telecommunication, the phase of the optical signal has become increasingly important as additional degree of freedom for transmitting information. A known concept is usually referred to as coherent detection. In coherent detection, an optical receiver provides (time dependent) electrical signals thus allowing determining the time dependent course of the optical signal with respect to its amplitude and phase. The time dependent course of the phase contains the digital data content of the optical signal.

Coherent detection in optical fiber systems is outlined in the articles “Coherent detection in optical fiber systems”, by Ezra Ip, Alan Pak Tao Lau, Daniel J. F. Burros, Joseph M. Kahn, 21 Jan. 1308, Vol. 16, No. 2, OPTICS EXPRESS, p. 753 ft or in “Phase- and Polarization-Diversity Coherent Optical Techniques”, by Leonid G. Kazovsky, JOURNAL OF LIGHTWAVE TECHNOLOGY, VOL 7, NO. 2, FEBRUARY 1989, page 219 ff. Calibration of optical downconverters for coherent detection is disclosed in WO 1510/105684 A1 by the same applicant.

D. M. Baney, B. Szafraniec, A. Motamedi, “Coherent optical spectrum analyzer,” Photonics Technology Letters, Vol. 14, pp. 355-357, (1302), describes the basic concept of a coherent optical spectrum analyzer (COSA), also referred to a Heterodyne Spectrum Analyzer. For coherent optical spectrum analysis, an optical input signal to be measured is combined with an optical local oscillator whose frequency can be swept across the measurement wavelength range. Optical mixing, due to the nonlinear dependence of the photocurrent on the optical field, allows for measurement of the input field strength. The detected intensity is composed of in-phase direct detection components and antiphase mixing beat terms. By subtracting the currents generated by a balanced photoreceiver (30), the direct detection can be reduced relative to the heterodyne signal.

Coherent optical spectrum analyzer are further disclosed, e.g., in D. Derickson, ed., Fiber Optic Test and Measurement, (Prentice Hall, 1997); B. Szafraniec, J. Y. Law, and D. M. Baney, “Frequency resolution and amplitude accuracy of the coherent optical spectrum analyzer with a swept local oscillator,” Optics Letters, Vol. 27, No. 21, pp. 1896-1898, (1302); B. Szafraniec, A. Lee, J. Y. Law, W. I. McAlexander, R. D. Pering, T. S. Tan, D. M. Baney, “Swept Coherent Optical Spectrum Analysis”, IEEE Transactions on Instrumentation and Measurements, Vol. 53, pp. 153-215, (1304);

A coherent optical receiver (30) for demodulating data content of differential phase-shift keying (DPSK) signals is disclosed in R. Lagenhorst, et al.; “Balanced Phase and Polarization Diversity Coherent Optical Receiver (30)”; IEEE Photonics Technology Letters, Vol. 3, No. 1, pp. 80-82 (1991); or Leonid G. Kazovsky; “Phase- and Polarization-Diversity Coherent Optical Techniques”; Journal of Lightwave Technology, Vol. 7, No. 2, pp, 279-292 (1989).

Coherent optical spectrum analyzer are also disclosed in US 1302/0122180 A1, US 1302/0120255 A1, US 1302/0167670 A1, US 1303/0011777 A1, US 1304/0022547 A1, US 1304/0070766 A1, US 1305/0012934 A1, US 1306/0115483 A1, U.S. Pat. No. 7,075,659 B2, U.S. Pat. No. 7,106,449 B2.

Coherent optical spectrum analyzer with a 3×3 or 4×4 coupler, resulting in three or more phase-diverse heterodyne signals are disclosed in U.S. Pat. No. 7,068,374 B2 or U.S. Pat. No. 7,054,012 B2.

### DISCLOSURE

It is an object of the invention to provide an improved optical spectrum analyzer. The object is solved by the independent claim(s). Further embodiments are shown by the dependent claim(s).

According to the present invention, a heterodyne optical spectrum analyzer is configured for analyzing spectral information of an optical input signal. The analyzer comprises a local oscillator source, an optical mixer, an opto-electrical receiver, and a signal processor. The local oscillator source is configured for generating an optical local oscillator signal. The optical mixer is configured for receiving the input signal and the local oscillator signal, and for outputting a plurality of different combined optical signals. Each combined optical signal is derived from the input signal as well as from the local oscillator signal. The opto-electrical receiver has a plurality (preferably eight) of inputs (for example photodiodes) configured for receiving the combined optical signals and for providing an opto-electrical conversion thereof. An output of the opto-electrical receiver is provided for outputting electrical signals representing the received combined optical signals. The signal processor is configured for deriving spectral (e.g. amplitude and phase) information of the input signal by analyzing the electrical signals.

The optical mixer is further configured for deriving a plurality of polarization diverse signals from the input signal, and for deriving a set of balanced quadrature signals for each polarization diverse signal by combining each polarization diverse signal with a signal derived from the local oscillator signal. Each of the polarization diverse signals has a different state of polarization. The derived sets of balanced quadrature signals represent the plurality of combined optical signals.

Embodiments according to the present invention thus allow higher accuracy in the determination of spectral information of the input signal with better power and wavelength accuracy, less polarization dependence, better stability over time, lower sensitivity against environmental disturbance and higher dynamic range with much smaller evaluation times compared to current heterodyne spectrum analyzers.

In one embodiment, the local oscillator signal is a variable local oscillator signal that can be varied in frequency. Preferably, the local oscillator source is configured for generating such variable local oscillator signal. The variable local oscillator signal may be a swept local oscillator signal sweeping in or over a given or defined frequency range or a range of frequencies. Thus measurements over a wide range of frequencies can be enabled exceeding the physical bandwidth of the incorporated electro-optical detection engine.

In one embodiment, wherein the local oscillator signal is a variable local oscillator signal, the signal processor is configured for deriving the spectral information of the input signal by analyzing the electrical signals in conjunction with the variation in frequency of the local oscillator. The signal processor may receive information about the variation in frequency (e.g. a sweep rate) from the local oscillator and/or a frequency measurement unit, which information might be instrument control information (e.g. for setting the variation in frequency of the local oscillator) or being derived by an actual measurement (e.g. of the local oscillator signal or a signal derived therefrom).

In one embodiment, the optical mixer is configured to derive the polarization diverse signals having orthogonal states of polarization with respect to each other. Thus the polarization properties of the input signal have no impact on the power accuracy of the measured spectral information. Furthermore even spectral resolved measurements of the input polarization properties of the input signal can be enabled.

In one embodiment, the optical mixer is configured to derive, from the input signal, two polarization diverse signals having orthogonal states of polarization, and to derive two sets of balanced quadrature signals for the two polarization diverse signals. Using balanced quadrature signals enables on one hand faster evaluation procedures, since at any instance in time slowly varying field amplitudes and phases can be reconstructed and used to replace rapidly varying interference signals. On the other hand the subtraction of the balanced signals removes the impact of temporal instationary input signals on the measured spectral properties, i.e. measurements with a higher dynamic range can be enabled.

In one embodiment, the opto-electrical receiver is configured to output the electrical signals as balanced electrical signals, preferably by combining each two signals having opposite signs, as readily known in the art and also disclosed by the documents cited in the introductory part of the description.

In one embodiment, the optical mixer comprises a first and a second polarization dependent beam splitter. The first polarization dependent beam splitter is configured for deriving a first plurality of polarization diverse signals from the local oscillator signal, with each polarization diverse signal having a different state of polarization. The second polarization dependent beam splitter is configured for deriving a second plurality of polarization diverse signals from the input signal, with each polarization diverse signal having a different state of polarization. Thus polarization independent or even polarization resolved measurements can be enabled.

In one embodiment, the optical mixer comprises a polarization modification device (which might also be referred to as phase shifter) for deriving a phase shift (preferably 90°) between at least two signals of the first plurality of polarization diverse signals and the second plurality of polarization diverse signals. Thus measurement of quadrature signals can be enabled allowing at any instance in time the reconstruction of slowly varying field amplitudes and phases. In one embodiment, the first plurality of polarization diverse signals have circular polarization, and the second plurality of polarization diverse signals have linear polarization. In another embodiment, the first plurality of polarization diverse signals have linear polarization, and the second plurality of polarization diverse signals have circular polarization

In one embodiment, the optical mixer comprises a combiner which is configured for combining the first plurality of polarization diverse signals and the second plurality of polarization diverse signals as received from the polarization modification device. Thus interference signals can be generated which are insensitive to environmental changes (e.g. vibrations) and have excellent long term stability. The combiner is preferably configured to have the same angle of incidence on its surfaces for the first plurality of polarization diverse signals as well as for the second plurality of polarization diverse signals. Transmission and reflections coefficients of the combiner are preferably close to 0.5 and are preferably configured to be essentially independent of the wavelength of the incident first plurality of polarization diverse signals and second plurality of polarization diverse signals.

In one embodiment, the optical mixer comprises a third and a fourth polarization dependent beam splitter. The third polarization dependent beam splitter is configured for deriving a third plurality of polarization diverse signals from a first plurality of combiner signals received from the combiner. The fourth polarization dependent beam splitter is configured for deriving a fourth plurality of polarization diverse signals from a second plurality of combiner signals received from the combiner. The fourth plurality of polarization diverse signals are complementary to the third plurality of polarization diverse signals, which means the phase difference between the third and forth plurality of signals is close to 180°. The third plurality of polarization diverse signals is preferably derived at two different states of polarization, thus representing quadrature signals for both states of polarization of the input signal. Alternatively or in addition, the fourth plurality of polarization diverse signals may also be provided at two different states of polarization, which may then also represent quadrature signals for both states of polarization of the input signal. Thus polarization resolved balanced quadrature signals can be created combining all the benefits discussed above.

The third and forth polarization dependent beam splitters are preferably configured to create a positional displacement essentially orthogonal to the positional displacement created by the first and second polarization dependent splitters.

In one embodiment, the polarization modification device comprises a first and a second polarization modification device (which may, for example, be retarder). The first polarization modification device is configured for receiving an output from the first polarization dependent beam splitter and for providing a first polarization modification output signal. The second polarization modification device is configured for receiving an output from the second polarization dependent beam splitter and for providing a second polarization modification output signal.

In one embodiment, the combiner comprises a beam splitter receiving the first polarization modification output signal and the second polarization modification output signal. The beam splitter is configured for providing the first plurality of combiner signals and the second plurality of combiner signals. Each of the first and second plurality of combiner signals comprises a partial beam being derived from the first polarization modification output signal and from the second polarization modification output signal. Transmission and reflections coefficients of the beam splitter are preferably selected to be close to 0.5 and are preferably configured to be essentially independent of the wavelength of the incident first plurality of polarization diverse signals and second plurality of polarization diverse signals.

In one embodiment, the heterodyne optical spectrum analyzer is configured that an individual time delay from a signal input of the optical mixer to the output of the opto-electrical receiver is essentially matched to be less than 10% of the inverse of the detection bandwidth.

In one embodiment, the heterodyne optical spectrum analyzer comprises a switch matrix configured to change the routing of the local oscillator signal in order to measure and recalibrate properties of the signal path.

In one embodiment, the heterodyne optical spectrum analyzer comprises an optical attenuator in the signal path configured to change the signal power incident on the mixer.

In one embodiment, the heterodyne optical spectrum analyzer comprises an absolute frequency reference, preferably realized by measuring the optical transmission profile of molecular or atomic transitions.

In one embodiment, the heterodyne optical spectrum analyzer comprises a relative frequency (wavelength) reference, preferably realized by an optical discriminator, where the optical discriminator is characterized by low thermal wavelength shift of below 1 pm/K.

In one embodiment, the signal processor is configured to use one or more calibration values, preferably stored within the signal processor or elsewhere, being indicative at least one of:
Wavelength dependent transmission, preferably optical losses, and opto-electrical conversion values within the heterodyne optical spectrum analyzer, preferably from the input to the electrical signals for each of the plurality of combined optical signals;
Wavelength dependent modulation depth of an interference term of the output of the opto-electrical receiver for any of the combined optical signals;
Time delay values from a signal input of the optical mixer to the output of the opto-electrical receiver for any of the plurality of the combined optical signals;
Frequency dependent amplitude and phase values of a signal input of the optical mixer to the output of the opto-electrical receiver for any of the plurality of the combined optical signals.

Data acquisition of the electrical signals representing the received combined optical signals is preferably made continuous during a continuous or stepped change of the local oscillator frequency.

In one embodiment, the signal processor is configured for performing at least one of:
Correcting the derived spectral information for timing, wavelength and frequency dependent errors according to given calibration values;
Reconstructing time dependent amplitude and phase of the input signal for time domain data;
Down-sampling and/or averaging of time domain data of the input signal;
Calculation power spectrum over frequency, wherein the measured spectrum information is corrected to account for non-uniformities in a frequency sweep rate of the swept local oscillator signal.

In one embodiment, data acquisition of the electrical signals representing the received combined optical signals is made in a burst mode during a stepped or continuous change of the local oscillator frequency, where preferably the detection bandwidth opto-electrical receiver is greater than the frequency change of the local oscillator frequency between successive bursts, and preferably where the frequency of the data acquisition bursts is synchronized with pattern repetition frequency of a modulated quasi-stationary input signal.

The signal processor may be configured for performing at least one of:
Correcting the burst data for timing, wavelength and frequency dependent errors taking into account the calibration values;
Reconstructing time dependent amplitude and phase of the signal for each burst;
Calculation of frequency domain data from amplitude and phase;
Stitching of the frequency domain data by taking into account the time dependent frequency change of the local oscillator to obtain spectral amplitude and phase over a frequency range exceeding the physical detection bandwidth;
Calculation of amplitude and phase time domain data from frequency domain data of amplitude and phase.

In one embodiment, the signal processor comprises a spectrum measurement module and a sweep rate correction module. The spectrum measurement module is configured for generating measured spectrum information. The sweep rate correction module is configured for correcting the measured spectrum information in response to a measured local oscillator frequency sweep rate information, wherein the measured spectrum information is corrected to account for non-uniformities in the frequency sweep rate of the swept local oscillator signal. Thus the impact of temporal changes of the sweep rate of the local oscillator on the measured spectral properties of the input signal can be minimized.

Embodiments of the invention can be partly or entirely embodied or supported by one or more suitable software programs, which can be stored on or otherwise provided by any kind of data carrier, and which might be executed in or by any suitable data processing unit.

### BRIEF DESCRIPTION OF DRAWINGS

Other objects and many of the attendant advantages of embodiments of the present invention will be readily appreciated and become better understood by reference to the following more detailed description of embodiments in connection with the accompanied drawing(s). Features that are substantially or functionally equal or similar will be referred to by the same reference sign(s).

FIG. 1 schematically illustrates an embodiment of a heterodyne optical spectrum analyzer 10 for analyzing spectrum information of an optical input signal 15.

FIG. 2 schematically illustrates, in greater detail, an embodiment of the optical mixer 25.

FIG. 3 shows exemplary the impact of the combined errors in a vector representation of the balanced quadrature signals S1 to 54 according to equations 8-11.

FIG. 4 illustrates schematically a flow chart of exemplary signal processing as provided by the signal processor 35 for one polarization direction.

Table 1 lists equations of the most relevant signals in the heterodyne optical spectrum analyzer 10.

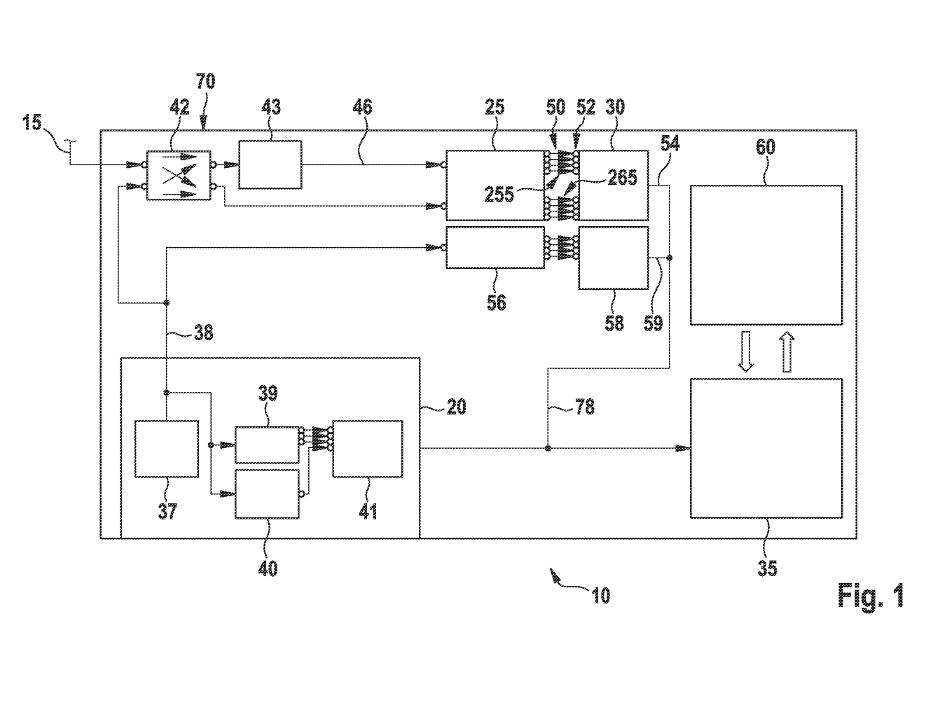

Turning now to FIG. 1, which schematically illustrates an embodiment of a heterodyne optical spectrum analyzer 10 for analyzing spectrum information of an optical input signal 15. The analyzer 10 comprises a local oscillator source 20, an optical mixer 25, an opto-electrical receiver 30, a signal-processor 35 as well as other components, which will be explained later in further detail.

The local oscillator source 20 comprises a laser unit 37 for generating an optical local oscillator signal 38, a wavelength reference unit 39, an absolute frequency reference unit 40 and analog boards 41. The wavelength reference unit 39 as well as the absolute frequency reference unit 40, both received the optical local oscillator signal 38, for measuring the current wavelength of the optical local oscillator signal 38. The analog boards 41 provide control signals indicative of the wavelength and power and other information on the actual state of the emitted local oscillator signal 38. Instead of the wavelength reference unit 39 and/or the absolute frequency reference unit 40, other measurement units for determining the current wavelength or frequency of the optical local oscillator signal 38 can be used accordingly. The wavelength reference unit 39 might be preferably embodied as an optical discriminator (converting wavelength information into power signals), where the optical discriminator preferably has low thermal wavelength shift and good long term stability of below 1 pm/K. The absolute frequency reference unit 40 might be preferably embodied by measuring the optical transmission profile of molecular or atomic transitions.

The optical input signal 15 as well as the optical local oscillator signal 38 are received by switch matrix 42. The switch matrix 42 allows to couple the known local oscillator signal 38 into the path used for routing the input signal 15 towards the optical mixer 25, thus allowing to re-measure optical transfer properties of the signal path to account for possible changes of the signal path over time and environmental conditions. In other words, the switch matrix 42 allows coupling either one of its inputs, namely the local oscillator signal 38 or the input signal 15, to its output.

An optical attenuator 43 receives the output of the switch matrix 42 allowing attenuating the signal in amplitude. In case of switching the input signal 15 (which shall be considered the following), the optical attenuator 43 allows attenuating the input signal 15 in amplitude to adapt the power of the input signal 15 to the properties of the local oscillator signal 38 and the mixer 25. The optical mixer 25 receives the output from the attenuator 43. The optical mixer 25 further receives the optical local oscillator signal 38.

The optical mixer 25 is configured for outputting a plurality of different combined optical signals derived from the optical input signal 15 and the local oscillator signal 38. In the embodiment shown here and as also explained later, the optical mixer 25 provides eight different combined optical signals 50.

The opto-electrical receiver 30 receives at its (in this preferred embodiment eight) inputs 52, which are preferably embodied as photodiodes, the combined optical signals 50. The opto-electrical receiver 30 provides an opto-electrical conversion of the received combined optical signals 50 and provides at digitized outputs 54 electrical signals representing the received combined optical signals 50.

A relative frequency measurement unit 56 also receives the optical local oscillator signal 38 and is configured to provide a signal indicative of the actual frequency of the local oscillator signal 38 with higher sampling rate and higher resolution compared to the wavelength reference unit 39. The signals derived from the relative frequency measurement unit 56 can subsequently be used to account and correct for distortions and fluctuations of the local oscillator signal 38 e.g. time dependent changes in the frequency change variation of the local oscillator signal 38. An opto-electrical receiver 58 provides an opto-electrical conversion of the output of the relative frequency measurement unit 56 and provides at digitized outputs 59 electrical signals to the signal processor 35.

The signal processor 35 receives the electrical signals from the opto-electrical receiver 30, the relative frequency measurement unit 56 as well as signals (line 78) derived from the absolute frequency reference unit 40, for deriving spectral information of the input signal 15 by analyzing the received electrical signals.

A system controller 60 is provided to set measurement settings, to control the individual elements and their interactions, and the measurement and data evaluation flow.

An external and pattern trigger 70 allows to synchronize the instrument with external events especially with the pattern repetition frequency of used within the generation of modulated quasi-stationary signals.

In operation, the optical mixer 25 receives the optical input signal 15 via the switch matrix 42 and the attenuator 43. The optical mixer 25 further receives the optical local oscillator signal 38 from the laser unit 37, the optical mixer 25 combines both signals 15 and 38 and outputs therefrom the different combined optical signals 50, which are then converted into electrical signals by the opto-electrical receiver 30. The signal processor 35 eventually derives spectrum information of the input signal 15 by analyzing the electrical signals provided by the opto-electrical receiver 30, as will also be explained later.

The laser unit 37 preferably is a variable laser unit allowing to provide a variable local oscillator signal 38 varying in frequency for example over a given range of frequencies. The laser unit 37 can be embodied, for example, by any variable wavelength laser as know in the art. The wavelength reference unit 39 as well as the absolute frequency reference unit 40 monitor the current applied frequency of the local oscillator signal 38 and provide that information via line 78 to the signal processor 35, for analyzing spectrum information of the input signal 15.

The switch matrix 42 allows to couple the known local oscillator signal 38 into the path used for routing the input signal 15 towards the optical mixer 25, thus allowing to re-measure the optical transfer properties of the signal path to account for possible changes of the signal path over time and environmental conditions.

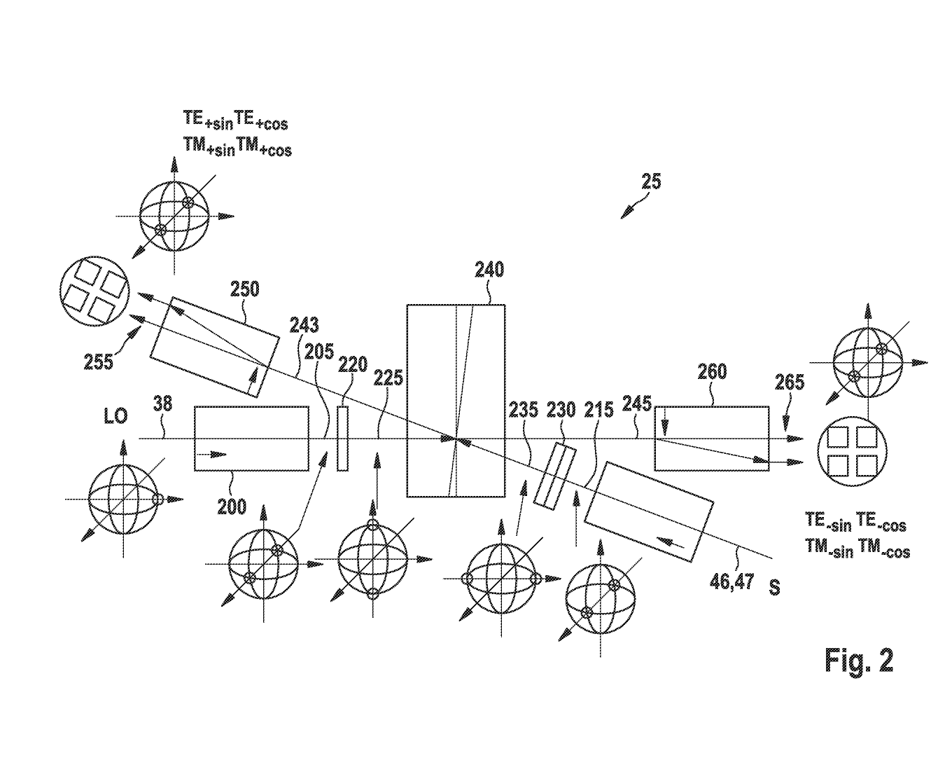

FIG. 2 schematically illustrates, in greater detail, an embodiment of the optical mixer 25. The optical mixer 25 receives the input signal 15, or correspondingly a signal derived therefrom, for example, after being processed by either the attenuator 43 or other elements (not shown in the figures). The input signal 15, or the corresponding signal derived therefrom, as seen and received by the optical mixer 25 shall be denoted S for the sake of clarity. The optical mixer 25 further receives the local oscillator signal 38, which shall also be denoted, for the sake of clarity, by LO. The local oscillator signal LO is coupled to a first polarization dependent beam splitter 200 which splits the local oscillator signal LO according to its state of polarization into two signals having a different state of polarization. The two output signals with different states of polarization shall be denoted as a first plurality of polarization diverse signals 205. Accordingly, the input signal S is coupled to a second polarization dependent beam splitter 210, which provides as output two signals with different states of polarization (the second plurality of polarization diverse signals) 215.

A first polarization modification device 220, preferably a quarter wavelength plate, receives the first plurality of polarization diverse signals 200 and derives therefrom polarization modified output signal 225. Accordingly, a second polarization modification device 230 receives the second plurality of polarization diverse signals 215 and provides a second polarization modified output signal 235 therefrom. The second polarization modification device 230 preferably is a half wavelength plate. However it should be pointed out that the function of the mixer 25 remains unchanged when first and second polarization modification devices 220 and 230 are interchanged.

The Poincare spheres shown in FIG. 2 indicate the evolution of the polarization states for the different signals for different positions within the optical mixer 25.

The polarization modification device 220 together with the second polarization modification device 230 provide a phase shifter for deriving a phase shift, here 90°, between at least two signals of the first plurality of polarization diverse signals 205 and the second plurality of polarization diverse signals 215. In other words, in a preferred embodiment the first plurality of polarization diverse signals 225 consist of circular polarized signals, and the second plurality of polarization diverse signals consist of linear polarized signals, or vice versa.

The optical mixer 25 further comprises a combiner receiving the first and second plurality of polarization diverse signals 225, 235 as respectively output by the first polarization modification device 220 and the second polarization modification device 230. The combiner 240, which shall be embodied here by a 50/50 beam splitter (i.e. a beam splitter having a transmission to reflection ratio of 50/50), is arranged with respect to its input beams, so that it combines the first plurality of polarization diverse signals 225 and the second plurality of polarization diverse signals 235. This results in a first 243 and a second 245 plurality of combiner signals being the superposition of the local oscillator signal 38, where the first 243 and a second 245 plurality of combiner signals are being complementary to each other. In other words, the interference term within the first 243 and a second 245 plurality of combiner signals has opposite sign (a phase shift of 180°).

A third polarization dependent beam splitter 250 receives the first plurality of combiner signals 243 from the combiner 240 and derives therefrom a third plurality of polarization diverse signals 255. Accordingly, a fourth polarization dependent beam splitter 260 receives the second plurality of combiner signals 245 from the combiner 240 and derives therefrom a fourth plurality of polarization diverse signals 265.

The third plurality of polarization diverse signals 255 and the second plurality of polarization diverse signals 265 are complimentary with respect to each other.

The third plurality of polarization diverse signals 255 and the fourth plurality of polarization diverse signals 265 represent the plurality of different combined optical signals 50 as also indicated in FIG. 1.

In the following, the most relevant signals in the heterodyne optical spectrum analyzer 10 shall be briefly explained with respect to the equations a listed in Table 1 of the drawings. Equation (1) describes the field of the optical input signal 15, and equation (2) describes the field of the optical local oscillator signal 38, with a being the amplitude and φ being the phase. At the end the parameters a (being the amplitude) and φ (being the phase of the input signal) have to be determined to represent the properties of the signal 15 that is tested. Equation (3) generally describes the optical phase function for the local oscillator signal 38, with equation (4) showing the phase function for a swept local oscillator signal and equation (5) for a static local oscillator signal 38, with γ being the sweep speed, and f being the optical frequency.

Equations (6) and (7) describe the interference signal resulting from coupling the optical input signal 15 and the local oscillator signal 38. Equations (8), (9), (10) and (11) show the oscillating terms for quadrature detection as resulting from the equation (7). Equations 6 and 7 are to be understood as being exemplary for any individual within the plurality of the combined signals 255 and 265. Equations 8 and 9 are exemplary for the plurality of balanced quadrature signals for one polarization of the LO and the signal S.

Equation (12) describes the amplitude of the signal S (see equation (1)) as expressed from the oscillating terms of equations (8) (11).

Equation (13) describes the deferential phase as the difference in phase between the local oscillator signal 38 and the optical input signal 15, also expressed using the oscillating terms of equations (8)-(11).

Equation (14) describes the signals as measured by the detectors 52 of the opto-electrical receiver 30, with i=1 . . . 4 for each polarization for the case of a swept local oscillator signal taking into account some relevant sources for distortions and errors. It should be noted that in total eight signals are measured. As can be seen within the measured signals there will be interactions between wavelength dependent, frequency dependent and timing dependent errors. Therefore it is preferable to take into account some measures that provide decoupling of individuals error contributions, i.e. matching of path length or time delays of different detections channels, nearly wavelength independent coupling ratios, matched frequency response of the channels

Doing so Equation (14) can be simplified to equation (14), showing the necessary correction values which have to be calibrated.

Calibration can be done within the instrument in the factory during fabrication and/or on a regular basis (e.g. at boot time, periodically, after certain changes in temperature, before each measurement or at combinations of the above conditions) and may not need certain signals to be present at the input. IL_{1,i} represents loss of the optical mixer 25 from input of the local oscillator signal 38 to the respective detector 52 of number i, which is dependent on the wavelength, and may be user recalibrated by having a signal input IL_{2,i} represents loss from the input for the optical input signal 15 (e.g. lines 46 or 47) to the respective detector 52 at number i, which is also dependent on wavelengths and may be user recalibrated by having a signal input. The term of equation 16 accounts for non-ideal interference in the combined signals to the respective detector 52 with number i, which is expected to have some frequency dependency needed to account for non-ideal interference affecting power accuracy. As indicated in equation (16), it can be assumed to be decoupled into a wavelength dependent part and a frequency dependent part.

Equation (17) relates to an error term of the phase, which is also expected to have some frequency dependency and can be decoupled into a wavelength dependent part and a frequency dependent part as indicated in equation (17). Tᵢ represents delays from input to the respective detector 52 with number i, which should be matched to be smaller than a few percent of the detection bandwidth.

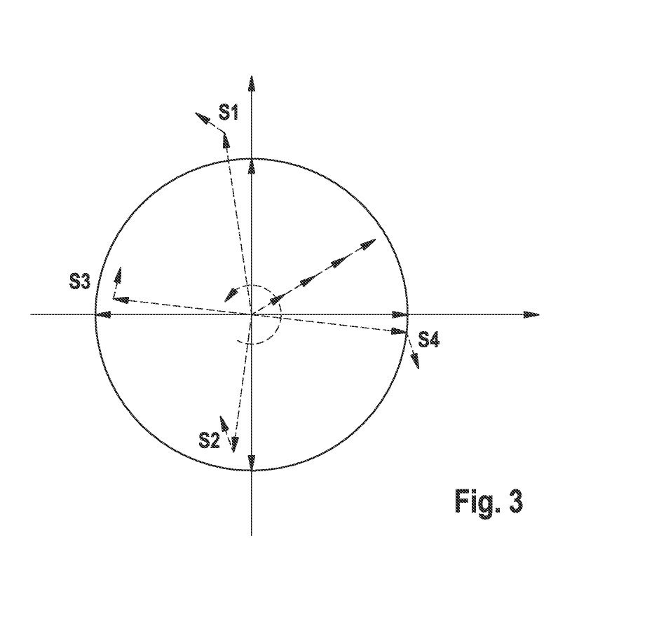

FIG. 3 shows exemplary the impact of the combined errors in a vector representation of the balanced quadrature signals S1 to S4 according to equations 8-11, The dashed lines show the real measured values from which in combination with the different calibration values the error-corrected representation of the input signal has to be calculated.

It is worth to note that due to the measurement principle by balanced quadrature detection at any instant in time the amplitude and phase function of the input signal can be reconstructed. This allows, in contrast to balanced detection, complete time domain processing for reconstruction of the spectral properties of the measured input signals. Furthermore the rapidly varying interference signals can be replaced with the underlying slowly varying amplitude and phase functions which can be processed numerically in a much more efficient and faster way.

To measure the spectral properties of the input signal S the frequency of the local oscillator signal can be changed in a stepped or continuous way, in combination with a continuous mode or repeated “burst mode” data acquisition of the combined optical signals 255 and 265. “Burst” mode means acquiring data over a finite time interval smaller than the total measurement time and repeating this and repeating until the total measurement time is reached. Preferably in this mode of operation the bandwidth of data acquisition is greater than the change of the local oscillator frequency during the time interval of the burst.

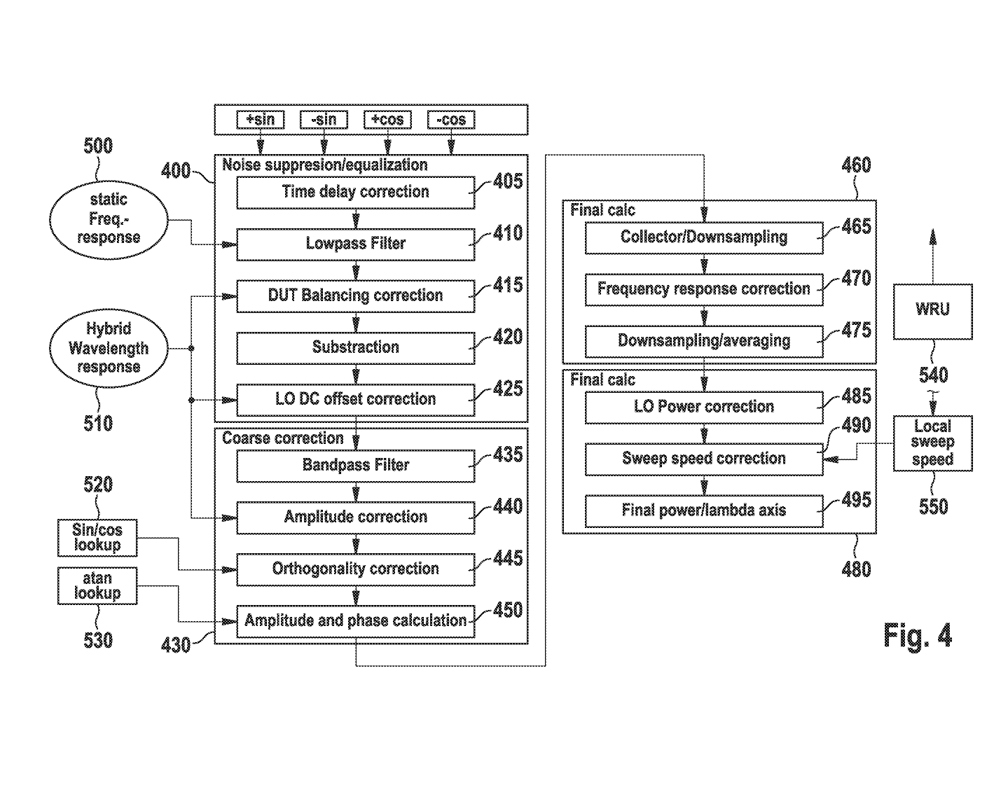

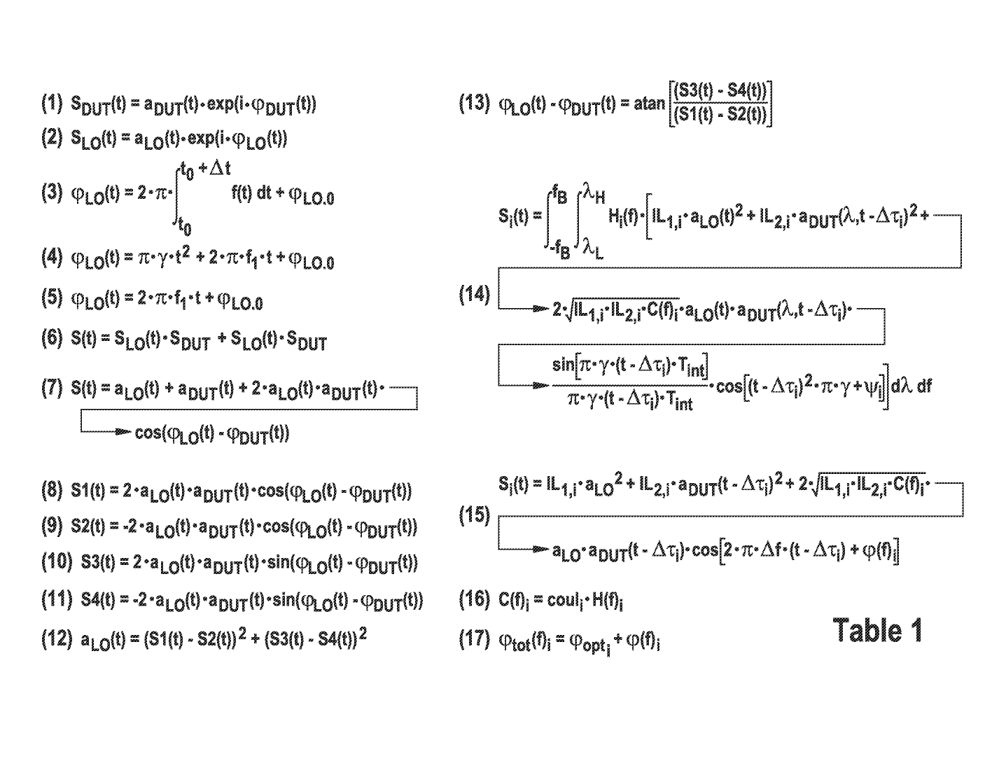

FIG. 4 illustrates schematically a flow chart of exemplary signal processing as provided by the signal processor 35 for one polarization direction (cf. FIG. 1). The second polarization direction can be evaluated in the same way. Evaluating the different polarization directions independently and taken into account the proper phase relationships, even the evaluation of spectral resolved polarization state of the input signal can be reconstructed.

The input data, i.e. the balanced quadrature signals, are in FIG. 4 denoted as +sin−sin+cos−cos and are preferably derived from the combined signals 255 and 265 which are generated from combining a swept local oscillator and a signal input, where data acquisition may be made in a continuous way during movement of the local oscillator.

In a noise suppression/equalization block 400, the individual time delays of the different channels may be corrected (405) for example by linear interpolation. Correcting for the frequency response function (e.g. based on calibration data 500) and lowpass filtering 410 may be accounted for by applying a FIR filter to the input data. Balancing correction 415, subtraction 420 and orthogonality correction i.e. correcting for individual losses and phase differences can be done by applying some trigonometric manipulations, see equations 18 to 23. Preferably the required sin and cos values are derived from tabulated lookup tables 520. As a result from DUT balancing correction, there might result a residual DC term arising from imperfect LO balancing correction, therefore a LO DC offset correction 425 might be necessary, Within the preceding steps, a mixer calibration data 510 can be used. Afterwards a further coarse correction 430 of the signals might be necessary. Bandpass filtering 435 improves the measureable dynamic range and the amplitude accuracy of the measured spectral properties of the input signal. Amplitude correction 440 based on the hybrid wavelength response calibration data improves the amplitude accuracy of the measured spectral properties. Finally based on arctan look up tables 530, the calculation of amplitude and phase of the underlying optical input signal is possible 450.

A first final calculation block 460 is then applied to the data. As mentioned before, within the data evaluation the rapidly varying interference signals can be replaced with the underlying slowly varying amplitude and phase functions, which can be averaged and down-sampled 465 to reduce the amount of data that needs to be processed, followed by a further frequency response correction 470 and a further data reduction 475. In a second final calculation block 480, the reduced amount of data is used, Correction can be done for changes and/or fluctuations of the local oscillator signal over time 485, fluctuations and changes of the local oscillator variations of the sweep speed 490 taking into account signals 550 from the fine frequency reference unit 56. Finally the final spectral information of the input signals is calculated 495, preferably in absolute power units (dBm or W) and wavelength units (nm or pm) taking into account 540 the WRU signals derived from the wavelength reference unit 39).

Finally correction can be made for fluctuation of the sweep speed of the local oscillator as well as for fluctuations of the power of the local oscillator signals. In combination with signals derived from the absolute and relative frequency reference 56 as well as the wavelength reference unit 39, spectral information of the input signal 15 with an absolute wavelength scale can be derived.

In an alternative way of data evaluation, spectral phase information can be derived also (beside spectral amplitude). This is preferably based on a “burst” mode data acquisition. Preferably the acquisition cycles of the bursts are synchronized for the case of a modulated signal with the modulation or pattern repetition frequency of the input signal. After correcting the burst data for timing, wavelength and frequency dependent errors taking into account the calibration values, the reconstructing of time domain amplitude and phase and thus the complex signal for each burst of acquired signals can be done. From this complex frequency domain data from amplitude and phase can be calculated by Fourier transforming the complex time domain data.

In the following a stitching process of the complex frequency domain data is done by taking into account the time dependent frequency change of the local oscillator 37 to obtain spectral amplitude and phase over a frequency range exceeding the physical detection bandwidth. This is done for both polarization axis of the input signal 15, so spectrally and polarization resolved information of the input signal is obtained, Finally the calculation of amplitude and phase time domain data from stitched complex frequency domain data is done, which can be used to calculate properties

1. A heterodyne optical spectrum analyzer configured for analyzing spectral information of an optical input signal, the analyzer comprising:
a local oscillator source configured for generating an optical local oscillator signal,
an optical mixer configured for receiving the input signal and the local oscillator signal, and for outputting a plurality of different combined optical signals each combined optical signal being derived from the input signal and the local oscillator signal,
an opto-electrical receiver having a plurality of inputs configured for receiving the combined optical signals and for providing an opto-electrical conversion thereof, and an output for outputting electrical signals representing the received combined optical signals, and
a signal processor configured for deriving spectral information of the input signal by analyzing the electrical signals, wherein the optical mixer is configured
splitting the input signal received at the optical mixer into a plurality of polarization diverse signals, each polarization diverse signal having a different state of polarization, and
following the splitting of the input signal received at the optical mixer, combining each of the polarization diverse signals with a signal derived from the local oscillator signal received at the optical mixer for obtaining a set of balanced quadrature signals for each of the polarization diverse signals,
the sets of balanced quadrature signals representing the plurality of combined optical signals.

2. The heterodyne optical spectrum analyzer of claim 1,
wherein the local oscillator signal is a variable local oscillator signal that can be varied in frequency.

3. The heterodyne optical spectrum analyzer of claim 2, wherein
the signal processor is configured for deriving the spectral information of the input signal by analyzing the electrical signals in conjunction with the variation in frequency of the local oscillator.

4. The heterodyne optical spectrum analyzer of claim 1, wherein
the opto-electrical receiver is configured to output the electrical signals as balanced electrical signals.

5. The heterodyne optical spectrum analyzer of claim 1, comprising at least one of:
the optical mixer is configured to derive the polarization diverse signals having orthogonal states of polarization with respect to each other;
the optical mixer is configured to derive from the input signal two polarization diverse signals having orthogonal states of polarization, and to derive two sets of balanced quadrature signals for each of the two polarization diverse signals.

6. The heterodyne optical spectrum analyzer of claim 1, wherein beam sizes of the local oscillator signal and the signal in the optical mixer are matched in size and wavefront curvature.

7. The heterodyne optical spectrum analyzer of claim 1, wherein the optical mixer comprises:
a first polarization dependent beam splitter for deriving a first plurality of polarization diverse signals from the local oscillator signal, each polarization diverse signal having a different state of polarization,
a second polarization dependent beam splitter for deriving a second plurality of polarization diverse signals from the input signal, each polarization diverse signal having a different state of polarization.

8. The heterodyne optical spectrum analyzer of claim 7, wherein the first and second polarization dependent beam splitters are configured to create an essentially matched positional displacement between the different beams of the plurality of polarization diverse signals.

9. The heterodyne optical spectrum analyzer of claim 7, wherein the optical mixer comprises:
at least one polarization modification device for deriving a phase shift between at least two signals of the first plurality of polarization diverse signals and the second plurality of polarization diverse signals.

10. The heterodyne optical spectrum analyzer of claim 9, wherein the optical mixer comprises:
a combiner for combining the first plurality of polarization diverse signals and the second plurality of polarization diverse signals as received from the polarization modification device.

11. The heterodyne optical spectrum analyzer of claim 10, wherein the optical mixer comprises:
a third polarization dependent beam splitter or deriving a third plurality of polarization diverse signals from a first plurality of combiner signals received from the combiner;
a forth fourth polarization dependent beam splitter for deriving a fourth plurality of polarization diverse signals from a second plurality of combiner signals received from the combiner, the fourth plurality of polarization diverse signals being complementary to the third plurality of polarization diverse signals.

12. The heterodyne optical spectrum analyzer of claim 1, wherein the signal processor is configured to use one or more calibration values being indicative at least one of:
Wavelength dependent transmission and opto-electrical conversion within the heterodyne optical spectrum analyzer;
wavelength dependent modulation depth of an interference term of the output of the opto-electrical receiver for any of the combined optical signals;
time delay values from a signal input of the optical mixer to the output of the opto-electrical receiver for any of the plurality of the combined optical signals;
frequency dependent amplitude and phase values of a signal input of the optical mixer to the output of the opto-electrical receiver for any of the plurality of the combined optical signals.

13. The heterodyne optical spectrum analyzer of claim 1, wherein the signal processor is configured for performing at least one of:
correcting the derived spectral information for timing, wavelength and frequency dependent errors according to given calibration values;
reconstructing time dependent amplitude and phase of the input signal for time domain data;
down-sampling and/or averaging of time domain data of the input signal;
calculation power spectrum over frequency, wherein the measured spectrum information is corrected to account for non-uniformities in a frequency sweep rate of the swept local oscillator signal.
